(19) United States
(12) Patent Application Publication
(10) Pub. No.: US 2026/0152609 A1
(43) Pub. Date: Jun. 4, 2026

(54) 3D PRINTING SUPPORT MATERIAL AND METHOD FOR MANUFACTURING SAME

(71) Applicant: OSAKA UNIVERSITY, Osaka (JP)

(72) Inventors: Michiya MATSUSAKI, Suita-shi, Osaka (JP); Zhengtian XIE, Suita-shi, Osaka (JP)

(21) Appl. No.: 18/705,643

(22) PCT Filed: Oct. 28, 2022
(86) PCT No.: PCT/JP2022/040319

§ 371 Date: Apr. 29, 2024

(30) Foreign Application Priority Data
Nov. 1, 2021 (JP) 2021-178638

(51) Int. Cl. C08J 3/075; B29C 64/314; B29C 64/40; B29K 105/00; B33Y 70/00; C08J 3/12; C08K 5/05

(52) U.S. Cl. CPC C08J 3/075; B29C 64/314; B29C 64/40; B33Y 70/00; C08J 3/12; C08K 5/05; B29K 2005/00; B29K 2105/0061; B29K 2105/0064; B29K 2105/251; C08J 2305/00

(57) ABSTRACT

A 3D printing support material is provided. The 3D printing support material includes gel particles and a gel particle stabilizer. The gel particles have a number-average diameter D50 that is 1 μm to 500 μm and a ratio (D90/D10) of D90 with respect to D10 is 7 or lower in the particle size distribution. The number-average diameter D50, D90 and D10 are particle sizes corresponding to a cumulative number of 50%, 90% and 10%, respectively, in a number-based particle size distribution.

### TECHNICAL FIELD

The present invention relates to a 3D printing support material, and a method of producing the same.

### BACKGROUND ART

Three-dimensional (3D) printing is an innovative technology that has emerged as a powerful platform for constructing complex structures and is applicable to a variety of applications. In conventional 3D printing, a 3D structure is usually constructed on a substrate by adding materials in layers. It is, however, difficult to directly apply this method to print a soft and hydrous biomaterial. This is because the gravity can cause a printed structure to collapse during a printing process. To overcome this drawback, 3D printing supported by a bath composed of a support medium has been developed. Among various bath systems, gel particle baths are one type of support materials frequently used in bioprinting because of high water content and smooth transition between a fluid state and a solid state.

In conjunction with the above, for example, Japanese Unexamined Patent Application Publication (Translation of PCT Application) No. 2021-512742 and Science, 365, 482-487 (2019) describe hydrogels that contain a gelatin microparticle slurry as a support material.

### SUMMARY OF INVENTION

### Technical Problem

The resolution of 3D printing using a gel particle bath as a support material depends on the particle size and the particle size distribution of gel particles. In the prior art, it was difficult to prepare a large amount of gel particles having a small particle size and a narrow particle size distribution in a simple manner.

An object of one aspect of the present invention is to provide a 3D printing support material that contains gel particles having a small particle size and a narrow particle size distribution and a method of producing the same.

### Solution to Problem

Concrete means for solving the above-described problems are as follows, and the present invention encompasses the following aspects. A first aspect is 3D printing support material that contains gel particles and a gel particle stabilizer, in which the gel particles have a number-average diameter D50, which is a particle size corresponding to a cumulative number of 50% in a number-based particle size distribution, of 1 μm to 500 μm, and a ratio (D90/D10) of D90, which is a particle size corresponding to a cumulative number of 90%, with respect to D10, which is a particle size corresponding to a cumulative number of 10%, is 7 or lower in the particle size distribution.

The gel particles may contain at least one selected from the group consisting of gellan gum, alginic acid, gelatin, collagen, gum arabic, xanthan gum, cellulose, hyaluronic acid, laminin, MATRIGEL (trade name), polyacrylic acid, poly(N-isopropylacrylamide), polymethacrylic acid, polyacrylamide, polystyrene sulfonic acid, polyvinyl alcohol, polyethylene glycol, starch, and fibrin. Further, the gel particle stabilizer may contain at least one selected from the group consisting of carboxylic acid compounds, water-soluble organic solvents, and salts.

A second aspect is a method of producing a 3D printing support material. The method includes preparing a mixture that contains a gel and a gel particle stabilizer solution and applying a shear force to the mixture to obtain a gel particle dispersion.

The gel may contain at least one selected from the group consisting of gellan gum, alginic acid, gelatin, collagen, gum arabic, xanthan gum, cellulose, hyaluronic acid, laminin, MATRIGEL (trade name), polyacrylic acid, poly(N-isopropylacrylamide), polymethacrylic acid, polyacrylamide, polystyrene sulfonic acid, polyvinyl alcohol, polyethylene glycol, starch, and fibrin. Further, the gel particle stabilizer may contain at least one selected from the group consisting of carboxylic acid compounds, water-soluble organic solvents, and salts. Moreover, the gel particles may have a number-average diameter D50, which is a particle size corresponding to a cumulative number of 50% in a number-based particle size distribution, of 1 μm to 500 μm, and a ratio (D90/D10) of D90, which is a particle size corresponding to a cumulative number of 90%, with respect to D10, which is a particle size corresponding to a cumulative number of 10%, may be 7 or lower in the particle size distribution.

### Advantageous Effects of Invention

According to the present invention, a 3D printing support material that contains gel particles having a small particle size and a narrow particle size distribution, and a method of producing the same can be provided.

### BRIEF DESCRIPTION OF DRAWINGS

FIG. 1 is an exemplary microscope image of the 3D printing support material according to Comparative Example 1.

FIG. 2 is an exemplary microscope image of the 3D printing support material according to Example 3.

FIG. 3 is an exemplary particle size distribution of the gel particles in the 3D printing support material according to Comparative Example 1.

FIG. 4 is an exemplary particle size distribution of the gel particles in the 3D printing support material according to Example 3.

FIG. 5 is an exemplary particle size distribution of the gel particles in the 3D printing support material according to Example 5.

FIG. 6 is an exemplary particle size distribution of the gel particles in the 3D printing support material according to Example 6.

FIG. 7 is an exemplary microscope image of collagen fibers formed in a 3D printing support material.

FIG. 8 is a graph showing the variation in the width of the collagen fibers shown in FIG. 7 in the lengthwise direction.

FIG. 9A is an exemplary three-dimensional structure formed in a 3D printing support material.

FIG. 9B is another exemplary three-dimensional structure formed in a 3D printing support material.

### DESCRIPTION OF EMBODIMENTS

The term “step” as used herein encompasses not only an independent step but also a step not clearly distinguishable from another step as long as the intended purpose of the step is achieved. If multiple substances correspond to a component in a composition, the content of the component in the composition means the total amount of the multiple substances present in the composition unless otherwise specified. Further, upper limit and lower limit values that are described for a numerical range in the present specification can be arbitrarily selected and combined. Embodiments of the present invention will now be described in detail. The embodiments described below are exemplifications of a 3D printing support material and a method of producing the same for embodying the technical ideas of the present invention, and the present invention is not limited to the 3D printing support material and the method of producing the same described below.

### 3D Printing Support Material

A 3D printing support material is configured to contain gel particles and a gel particle stabilizer. The gel particles constituting the 3D printing support material may have a number-average diameter D50, which is a particle size corresponding to a cumulative number of 50% in a number-based particle size distribution, of, for example, 1 μm to 500 μm. Further, in the particle size distribution, a ratio (D90/D10) of D90, which is a particle size corresponding to a cumulative number of 90%, with respect to D10, which is a particle size corresponding to a cumulative number of 10%, may be, for example, 7 or lower.

In the 3D printing support material, by incorporating the gel particle stabilizer in addition to the gel particles, a prescribed number-average diameter D50 and a prescribed ratio D90/D10 can be achieved. This enables to produce a desired structure with excellent resolution in 3D printing. Further, the 3D printing support material can be efficiently produced by the below-described production method.

The number-average diameter D50 of the gel particles may be preferably 0.1 μm or more, 10 μm or more, 15 μm or more, or 20 μm or more. Meanwhile, the number-average diameter D50 of the gel particles may be preferably 200 μm or less, 50 μm or less, 40 μm or less, or 30 μm or less. Further, the ratio D90/D10 of the gel particles may be, for example, 10 or lower, 7 or lower, 6 or lower, 5 or lower, 4 or lower, or 3 or lower. A lower limit of the ratio D90/D10 of the gel particles may be, for example, 1 or higher, or 2 or higher.

The D10 of the gel particles, which is a particle size corresponding to a cumulative number of 10% in a particle size distribution, may be, for example, 5 μm to 50 μm. The D10 may be preferably 8 μm or more, 10 μm or more, or 12 μm or more, but preferably 40 μm or less, 30 μm or less, 20 μm or less, or 16 μm or less. The D90 of the gel particles, which is a particle size corresponding to a cumulative number of 90% in a particle size distribution, may be, for example, 20 μm to 100 μm. The D90 may be preferably 25 μm or more, 30 μm or more, or 35 μm or more, but preferably 80 μm or less, 60 μm or less, 40 μm or less, or 38 μm or less.

The number-based particle size distribution of the gel particles can be obtained by, for example, measuring the particle size of individual gel particles using an image analysis software in a microscope image obtained by observing the 3D printing support material under a confocal laser scanning microscope.

As a gel material constituting the gel particles contained in the 3D printing support material, any substance that can be gelled by an ion addition, a temperature change, or the like can be used as long as it does not adversely affect the formation of a structure formed by 3D printing. Examples of such a gel material include gums such as gellan gum (GG), as well as alginic acid, polyacrylic acid, polyglutamic acid, polyaspartic acid, gelatin, collagen, gum arabic, xanthan gum, cellulose, hyaluronic acid, laminin, MATRIGEL (trade name), polyacrylic acid, poly(N-isopropylacrylamide), polymethacrylic acid, polyacrylamide, polystyrene sulfonic acid, polyvinyl alcohol, polyethylene glycol, starch, and fibrin. The gel material may preferably contain at least one selected from the group consisting of gellan gum, alginic acid, gelatin, collagen, gum arabic, xanthan gum, cellulose, hyaluronic acid, laminin, MATRIGEL (trade name), polyacrylic acid, poly(N-isopropylacrylamide), polymethacrylic acid, polyacrylamide, polystyrene sulfonic acid, polyvinyl alcohol, polyethylene glycol, starch, and fibrin.

The gel material may more preferably contain at least one selected from the group consisting of gellan gum, collagen, xanthan gum, hyaluronic acid, laminin, MATRIGEL (trade name), polyacrylic acid, poly(N-isopropylacrylamide), polymethacrylic acid, polyacrylamide, polystyrene sulfonic acid, polyvinyl alcohol, polyethylene glycol, starch, and fibrin.

The gel material constituting the gel particles may be a hydrogel as well. The gel particles may be constituted by a single kind of gel material, or a combination of two or more kinds of gel materials. It is noted here that MATRIGEL is the trade name of an extracellular matrix sold by BD Biosciences, and is a mixture of laminin, nidogen, collagen, heparan sulfate proteoglycan, and the like.

The gel material constituting the gel particles may be preferably a gum. Examples of the gum include plant-derived gums, bacteria-derived gums, and algae-derived gums. Specific examples of the plant-derived gums include guar gum, locust bean gum, cassia gum, tragacanth gum, tara gum, karaya gum, gum acacia, ghatti gum, cherry gum, cashew gum, apricot gum, tamarind gum, mesquite gum, larch gum, psyllium, and fenugreek gum. Examples of the bacteria-derived and algae-derived gums include xanthan gum, seaweed gum, gellan gum, agar gum, carrageenan, and curdlan.

Among these gums, gellan gum (GG) is a natural linear high-molecular-weight polysaccharide that is extracellularly produced by Pseudomonas elodea using glucose or the like as a carbon source. GG forms a transparent, heat-resistant, and acid-resistant gel in the presence of a monovalent or divalent metal salt. GG is available in two forms, which are HA gellan gum having a high acyl group content and LA gellan gum from which acyl groups are removed, and either of these forms may be used in the present invention. Alternatively, both forms of GG may be used in combination. GG is commercially available as, for example, NANOGEL (registered trademark)-TC, GROVGEL, AppliedGel, PHYTAGEL (trademark), or GELRITE. In addition to the gel material, the gel particles may contain a liquid carried by the gel material. The liquid carried by the gel material can be selected as appropriate in accordance with the type and the like of the gel material. Specific examples of the liquid carried by the gel material include water and phosphate buffered saline.

The content ratio of the gel material in the gel particles can be selected as appropriate in accordance with, for example, the type of the gel material and the type of the liquid carried by the gel material. The content ratio of the gel material in the gel particles may be, for example, 0.01% by mass to 30% by mass. The content ratio of the gel material in the gel particles may be preferably 0.1% by mass or more, or 0.3% by mass or more, but preferably 10% by mass or less, 5% by mass or less, 2% by mass or less, 1% by mass or less, or 0.8% by mass or less.

The gel particle stabilizer contained in the 3D printing support material is not particularly limited as long as it exhibits a property of removing at least a portion of a solvent constituting a gel from the gel. The gel particle stabilizer may be selected as appropriate in accordance with the gel material constituting the gel particles. The gel particle stabilizer is preferably water-soluble. The term “water-soluble” used herein means that the solubility at 25° C. is 1 g or more with respect to 100 g of pure water.

Specific examples of the gel particle stabilizer include carboxylic acid compounds, water-soluble organic solvents, and salts. Specific examples of the carboxylic acid compounds include: monocarboxylic acids, such as lactic acid and glycolic acid; dicarboxylic acids, such as malic acid; and tricarboxylic acids, such as citric acid. These carboxylic acid compounds may be used in the form of a salt with an alkali metal, an alkaline earth metal, or the like. Examples of the water-soluble organic solvents that may be used as the gel particle stabilizer include: alcohols, such as ethanol, propanol, and isopropanol; and nitriles, such as acetonitrile. Examples of the salts include alkali metal salts and alkaline earth metal salts, such as calcium chloride, sodium chloride, potassium chloride, magnesium chloride, aluminum chloride, sodium sulfate, calcium sulfate, magnesium sulfate, potassium sulfate, sodium nitrate, potassium nitrate, calcium nitrate, sodium carbonate, sodium bicarbonate, potassium carbonate, and potassium bicarbonate.

From the standpoint of the dispersion stability of the gel particles, the gel particle stabilizer is preferably a carboxylic acid compound, more preferably a polycarboxylic acid compound, such as a dicarboxylic acid or a tricarboxylic acid.

The 3D printing support material may further contain a liquid medium in addition to the gel particles and the gel particle stabilizer. The liquid medium may be any liquid medium that can dissolve the gel particle stabilizer, and the liquid medium may contain, for example, water. The concentration of the gel particle stabilizer in the liquid medium may be selected as appropriate in accordance with the type and the like of the gel particle stabilizer. For example, when the gel particle stabilizer is a carboxylic acid compound, the concentration of the gel particle stabilizer in the liquid medium may be 0.1 mM to 1 M. When the gel particle stabilizer is a carboxylic acid compound, the concentration of the gel particle stabilizer in the liquid medium may be preferably 10 mM or higher, 100 mM or higher, 200 mM or higher, 300 mM or higher, or 400 mM or higher, but preferably 0.7 M or lower, 0.6 M or lower, or 0.5 M or lower. For example, when the gel particle stabilizer is a water-soluble organic solvent, the concentration of the gel particle stabilizer in the liquid medium may be 1% by volume to 99% by volume. When the gel particle stabilizer is a water-soluble organic solvent, the concentration of the gel particle stabilizer in the liquid medium may be preferably 5% by volume or higher, 10% by volume or higher, 20% by volume or higher, 25% by volume or higher, or 30% by volume or higher, but preferably 60% by volume or lower, 50% by volume or lower, 40% by volume or lower, or 35% by volume or lower.

When the 3D printing support material contains a liquid medium, the concentration of the gel particles in the 3D printing support material may be, for example, 1% by volume to 99% by volume. The concentration of the gel particles in the 3D printing support material containing a liquid medium may be preferably 10% by volume or higher, or 30% by volume or higher, but preferably 80% by volume or lower, or 70% by volume or lower.

The 3D printing support material may also contain a surfactant as required. The surfactant may be any of, for example, nonionic, cationic, anionic, or amphoteric surfactants, and may be preferably a nonionic surfactant. Examples of the nonionic surfactant include polyoxyalkylene alkyl ethers, polyoxyethylene-polyoxypropylene alkyl ethers (in which ethylene oxide and propylene oxide may be added in a random or block form), polyethylene glycol propylene oxide adducts, polypropylene glycol ethylene oxide adducts, and glycerin fatty acid esters and ethylene oxide adducts thereof. The content of the surfactant in the 3D printing support material may be, for example, more than 0% by mass but 5% by mass or less. The content of the surfactant may be preferably 0.01% by mass or more, or 0.1% by mass or more. Meanwhile, the content of the surfactant may be preferably 2% by mass or less, 1% by mass or less, 0.5% by mass or less, 0.1% by mass or less, or 0.01% by mass or less.

The 3D printing support material can be used in 3D printing. For example, 3D printing can be performed by discharging a 3D printing ink in a desired shape into the 3D printing support material. The 3D printing ink may contain an organic material such as collagen, fibrinogen, gelatin, or alginic acid, or an inorganic material such as silica or nanoclay.

### Method of Producing 3D Printing Support Material

A method of producing a 3D printing support material may include: the preparation step of preparing a mixture that contains a gel and a gel particle stabilizer; and the dispersion step of applying a shear force to the thus prepared mixture to obtain gel particles. A dispersion of the gel particles obtained in the dispersion step may constitute a 3D printing support material.

By applying a shear force to a gel in the presence of a gel particle stabilizer, a 3D printing support material that contains gel particles having a small particle size and a narrow particle size distribution can be efficiently produced with excellent productivity. It is noted here that, when gel particles are prepared by applying a shear force to a gel in the absence of a gel particle stabilizer, the resulting gel particles exhibit a wide particle size distribution in which the ratio (D90/D10) is higher than 7.

The gel contained in the mixture may be any gel that is formed by supporting the above-described liquid on the above-described gel material, and the gel material and the liquid that constitute the gel may be selected as appropriate in accordance with the intended purpose and the like. The gel can be prepared by, for example, mixing the gel material and the liquid, heating the resulting mixture to dissolve the gel material in the liquid, and subsequently cooling the resultant to cause gelling. Alternatively, the gel may be prepared by a chemical reaction.

The gel constituting the mixture may be in a particulate form. A particulate gel can be prepared by, for example, applying an appropriate shear force to the prepared gel. Examples of a method of applying a shear force include a method using a homogenizer, an ultrasonication method, and a method using a filter mesh.

The details of the gel particle stabilizer contained in the mixture are as described above. The mixture may further contain a liquid medium in addition to the gel particles and the gel particle stabilizer. The liquid medium may be any liquid medium that can dissolve the gel particle stabilizer, and the liquid medium may contain, for example, water. The concentration of the gel particle stabilizer in the liquid medium may be selected as appropriate in accordance with the type and the like of the gel particle stabilizer. For example, when the gel particle stabilizer is a carboxylic acid compound, the concentration of the gel particle stabilizer in the liquid medium may be 0.1 mM to 1 M. When the gel particle stabilizer is a carboxylic acid compound, the concentration of the gel particle stabilizer in the liquid medium may be preferably 10 mM or higher, 100 mM or higher, 200 mM or higher, 300 mM or higher, or 400 mM or higher, but preferably 0.7 M or lower, 0.6 M or lower, or 0.5 M or lower. For example, when the gel particle stabilizer is a water-soluble organic solvent, the concentration of the gel particle stabilizer in the liquid medium may be 1% by volume to 99% by volume. When the gel particle stabilizer is a water-soluble organic solvent, the concentration of the gel particle stabilizer in the liquid medium may be preferably 5% by volume or higher, 10% by volume or higher, 20% by volume or higher, 25% by volume or higher, or 30% by volume or higher, but preferably 60% by volume or lower, 50% by volume or lower, 40% by volume or lower, or 35% by volume or lower.

When the mixture contains a liquid medium, the concentration of the gel in the mixture may be, for example, 1% by volume to 99% by volume. The concentration of the gel in the mixture may be preferably 10% by volume or higher, or 30% by volume or higher, but preferably 80% by volume or lower, or 70% by volume or lower.

In the dispersion step, a shear force is applied to the thus prepared mixture to obtain gel particles. Examples of a method of applying a shear force include a method using a homogenizer, an ultrasonication method, and a method using a filter mesh.

The gel particles obtained in the dispersion step may have a number-average diameter D50, which is a particle size corresponding to a cumulative number of 50% in a number-based particle size distribution, of 1 μm to 500 μm. Further, in the particle size distribution of the gel particles, a ratio (D90/D10) of D90, which is a particle size corresponding to a cumulative number of 90%, with respect to D10, which is a particle size corresponding to a cumulative number of 10%, may be 7 or lower. The details of the gel particles obtained in the dispersion step may be the same as those in the above-described 3D printing support material.

### EXAMPLES

The present invention will now be described more concretely by way of Examples; however, the present invention is not limited to the below-described Examples.

### Example 1

A gellan gum (GG) powder (trade name: KELCOGEL AFT; manufactured by Sansho Co., Ltd.) in an amount of 200 mg was added to 40 mL of phosphate buffered saline (PBS), and the resultant was heated at 100° C. for 3 hours to dissolve the GG powder and thereby obtain a GG solution. After the dissolution, the GG solution was maintained at room temperature for 3 hours to be gelled. Subsequently, the resulting GG gel was pulverized by a 6-minute treatment using a homogenizer to obtain GG particles.

After adding 4.2 mL of a 0.5 M aqueous trisodium citrate solution to 10 mL of the pulverized GG particles, the resultant was treated for 6 minutes using a homogenizer. Thereafter, air bubbles were removed by 3-minute centrifugation at 2,000 rpm, whereby a 3D printing support material (0.15 M TSC) was obtained.

### Example 2

A 3D printing support material (0.3 M TSC) was obtained in the same manner as in Example 1, except that a 1 M aqueous trisodium citrate solution was used, and the final concentration of trisodium citrate was adjusted to be 0.3 M.

### Example 3

A 3D printing support material (0.45 M TSC) was obtained in the same manner as in Example 1, except that a 1.5 M aqueous trisodium citrate solution was used, and the final concentration of trisodium citrate was adjusted to be 0.45 M.

### Example 4

A 3D printing support material (0.6 M TSC) was obtained in the same manner as in Example 1, except that a 2 M aqueous trisodium citrate solution was used, and the final concentration of trisodium citrate was adjusted to be 0.6 M.

### Example 5

A 3D printing support material (20% EtOH) was obtained in the same manner as in Example 1, except that 2.5 mL of a 99% aqueous ethanol solution was used in place of the aqueous trisodium citrate solution, and the final concentration of ethanol was adjusted to be 20%.

### Example 6

A 3D printing support material (30% EtOH) was obtained in the same manner as in Example 1, except that 4.2 mL of a 99% aqueous ethanol solution was used in place of the aqueous trisodium citrate solution, and the final concentration of ethanol was adjusted to be 30%.

### Example 7

A 3D printing support material (ACN) was obtained in the same manner as in Example 1, except that 4.2 mL of a 99% aqueous acetonitrile solution was used in place of the aqueous trisodium citrate solution, and the final concentration of acetonitrile was adjusted to be 30%.

### Comparative Example 1

A 3D printing support material (PBS) was obtained in the same manner as in Example 1, except that 4.2 mL of phosphate buffered saline (PBS) was used in place of the aqueous trisodium citrate solution.

### Evaluation

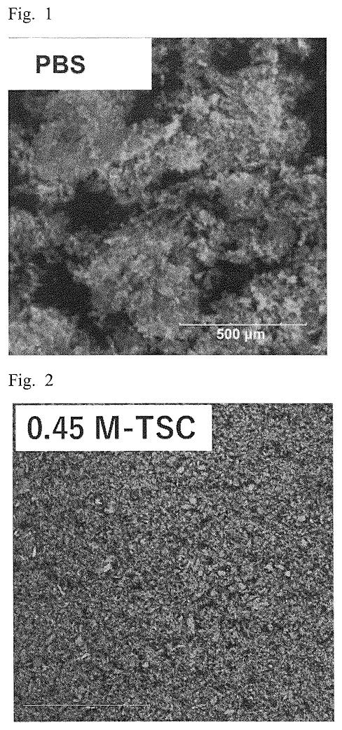

A 3D printing support material 1 for microscope observation was obtained in the same manner as in Example 3, except that a fluoresceinyl glycinamide-modified GG powder used. Further, a 3D printing support material 2 for microscope observation was obtained in the same manner using PBS in place of the aqueous trisodium citrate (TSC) solution. The thus obtained 3D printing support materials were each observed under a confocal laser scanning microscope (CLSM, FV-3000) to obtain microscope images. The results thereof are shown in FIGS. 1 and 2.

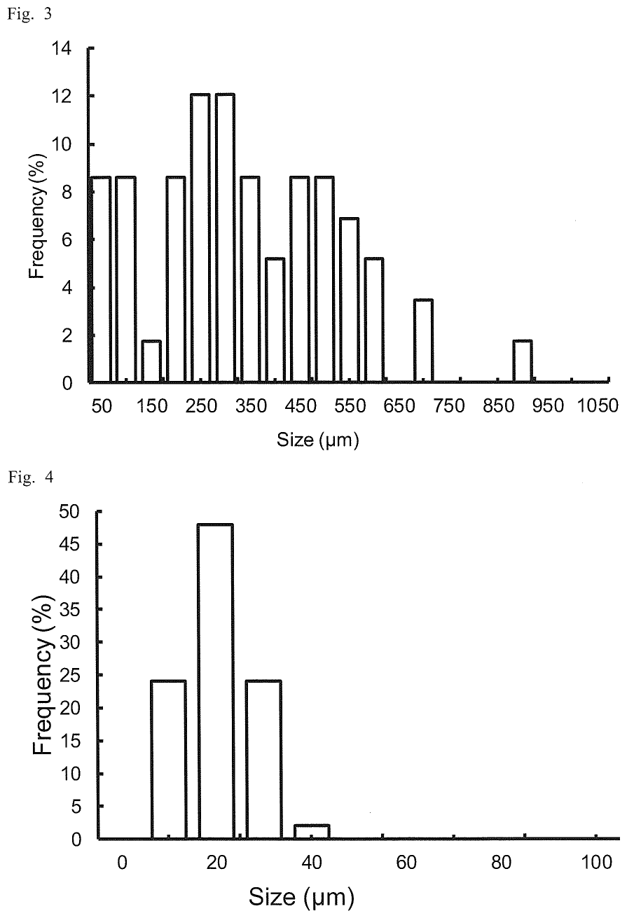

From each of the thus obtained microscope images, the size of GG particles was measured using an image analysis software (Image-J) to obtain a number-based particle size distribution. The results thereof are shown in FIGS. 3 and 4.

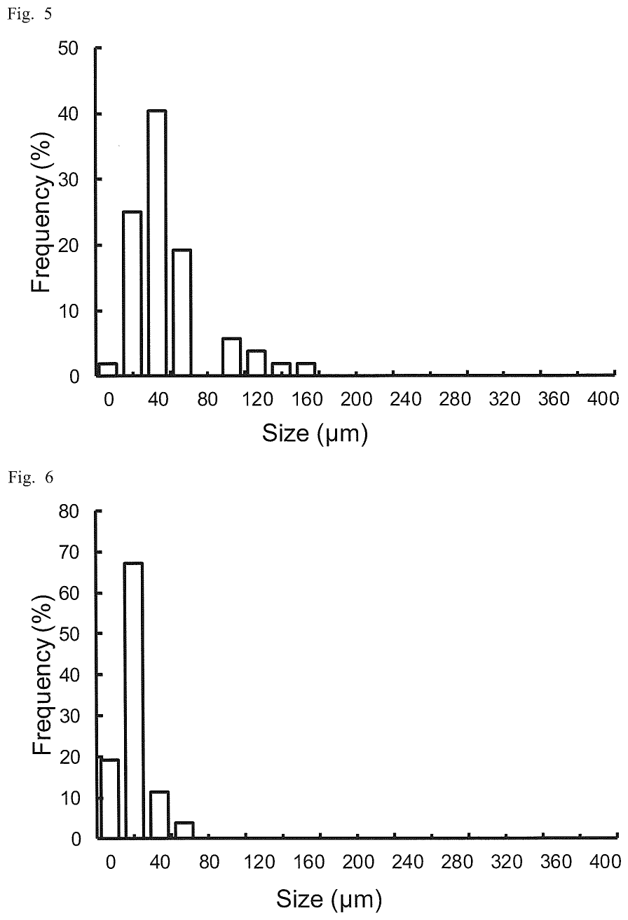

A particle size distribution was obtained in the same manner for each of the 3D printing support materials obtained by adjusting the final concentration of ethanol to be 20% or 30%. The results thereof are shown in FIGS. 5 and 6.

From each of the above-obtained particle size distributions, the number-average diameter D50 and the ratio (D90/D10) were determined. The results thereof are shown in Table 1.

TABLE 1

| | D10 | D50 | D90 | D90/ |
|---|---|---|---|---|
| | (μm) | (μm) | (μm) | D10 |
| PBS | 69.6 | 300.8 | 500.1 | 7.2 |
| 0.45M TSC | 14.7 | 25.9 | 35.6 | 2.4 |
| 30% EtOH | 18.3 | 26.9 | 44.5 | 2.4 |
| 20% EtOH | 21.6 | 47.2 | 108.0 | 5.0 |

### Preparation of Collagen Ink

A collagen powder (manufactured by Nippi, Inc.) was added to 0.02 M acetic acid, and the resultant was treated for 6 minutes using a homogenizer and then maintained at 4° C. for 24 hours to completely dissolve the collagen powder. The thus obtained collagen solution was centrifuged at 4,000 rpm for 5 minutes to remove air bubbles, whereby a collagen ink having a collagen concentration of 10 mg/mL was prepared.

### Printing Process 1

The collagen ink was linearly discharged from a 20-gauge (inner diameter: 600 μm) nozzle into a 25° C. bath containing a 3D printing support material. The moving speed of the nozzle was set at 2 mm/s. The thus printed collagen fibers in the bath were maintained at room temperature for 1 hour to be gelled. These fibers were taken out using a pair of forceps, and subsequently washed with a 50% ethanol solution to remove GG particles. The thus obtained fibers were immersed and crosslinked with 0.5 v/v % glutaraldehyde in a 50% ethanol solution at 37° C. for 24 hours. Thereafter, the thus obtained sample was washed by 24-hour immersion in PBS, and then subjected to a mechanical test.

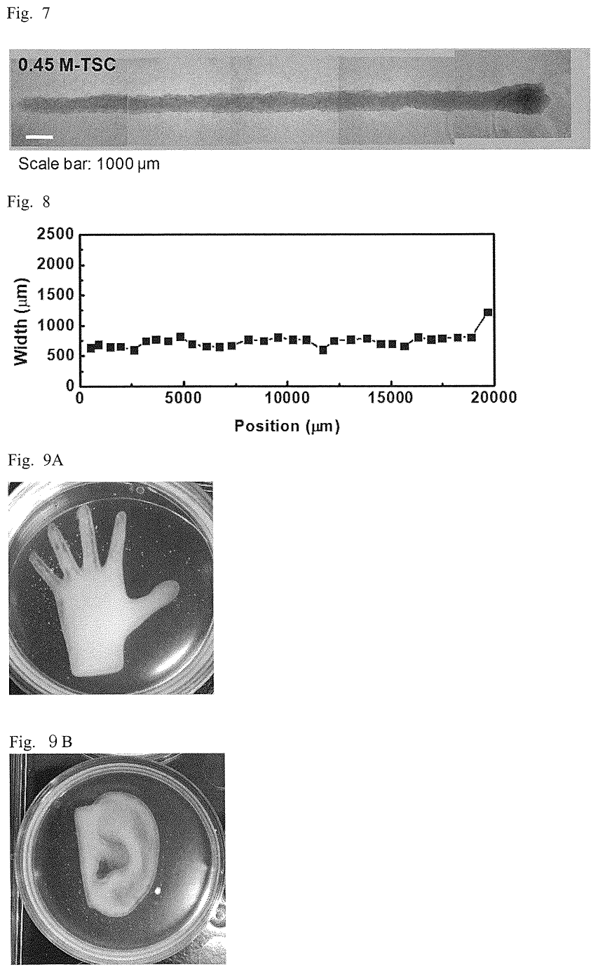

A microscope image of the fibers obtained using the above-prepared 3D printing support material (0.45 M TSC) is shown in FIG. 7. In addition, the variation in the width of the fibers in the lengthwise direction, which was measured from the microscope image, is shown in FIG. 8. It is noted here that the obtained fibers had an average diameter of about 800 μm. The fibers obtained after the crosslinking had a tensile strength of about 300 kPa.

Fibers obtained after the crosslinking in the same manner using the above-prepared 3D printing support material (30% EtOH) had a tensile strength of about 200 kPa. It is noted here that, when fibers were prepared in the same manner using the above-prepared 3D printing support material (PBS), the fibers could not be taken out of the bath.

### Printing Process 1

Using a 3D printer (Bio-X) equipped with a 25-gauge (inner diameter: 260 μm), the collagen ink was discharged in programmed routes into a 25° C. bath containing the above-prepared 3D printing support material (0.3 M TSC) to form three-dimensional structures. The thus formed structures are shown in FIGS. 9A and 9B.

From the above, it is seen that high-resolution 3D printing can be realized by using the 3D printing support material of the present invention as a bath.

The disclosure of Japanese Patent Application No. 2021-178638 (filing date: Nov. 1, 2021) is incorporated herein by reference in its entirety. All documents, patent applications, and technical standards cited in the present description are incorporated herein by reference to the same extent as in cases where the individual documents, patent applications, and technical standards are specifically and individually described to be incorporated by reference.

1. A 3D printing support material, comprising:
gel particles; and
a gel particle stabilizer,
wherein
the gel particles have a number-average diameter D50, which is a particle size corresponding to a cumulative number of 50% in a number-based particle size distribution, of 1 μm to 500 μm, and
a ratio (D90/D10) of D90, which is a particle size corresponding to a cumulative number of 90%, with respect to D10, which is a particle size corresponding to a cumulative number of 10%, is 7 or lower in the particle size distribution.

2. The support material according to claim 1, wherein the gel particles comprise at least one selected from the group consisting of gellan gum, alginic acid, gelatin, collagen, gum arabic, xanthan gum, cellulose, hyaluronic acid, laminin, MATRIGEL (trade name), polyacrylic acid, poly(N-isopropylacrylamide), polymethacrylic acid, polyacrylamide, polystyrene sulfonic acid, polyvinyl alcohol, polyethylene glycol, starch, and fibrin.

3. The support material according to claim 1, wherein the gel particle stabilizer comprises at least one selected from the group consisting of carboxylic acid compounds, water-soluble organic solvents, and salts.

4. A method of producing a 3D printing support material, the method comprising:
preparing a mixture that comprises a gel and a gel particle stabilizer solution; and
applying a shear force to the mixture to obtain a gel particle dispersion.

5. The method according to claim 4, wherein the gel comprises at least one selected from the group consisting of gellan gum, alginic acid, gelatin, collagen, gum arabic, xanthan gum, cellulose, hyaluronic acid, laminin, MATRIGEL (trade name), polyacrylic acid, poly(N-isopropylacrylamide), polymethacrylic acid, polyacrylamide, polystyrene sulfonic acid, polyvinyl alcohol, polyethylene glycol, starch, and fibrin.

6. The method according to claim 4, wherein the gel particle stabilizer solution comprises at least one selected from the group consisting of carboxylic acid compounds, water-soluble organic solvents, and salts.

7. The method according to claim 4, wherein
the gel particle dispersion has a number-average diameter D50, which is a particle size corresponding to a cumulative number of 50% in a number-based particle size distribution, of 1 μm to 500 μm, and
a ratio (D90/D10) of D90, which is a particle size corresponding to a cumulative number of 90%, with respect to D10, which is a particle size corresponding to a cumulative number of 10%, is 7 or lower in the particle size distribution.
